(19) United States
(12) Patent Application Publication
(10) Pub. No.: US 2004/0196655 A1
(43) Pub. Date: Oct. 7, 2004

(54) Flashlight with spare illuminant

(76) Inventor: Man Ho Yang, Hong Kong (CN)

Correspondence Address: Marlana Titus, Nash & Titus, 6005 Riggs Road, Laytonsville, MD, 20882, US

(21) Appl. No.: 10/487,371

(22) PCT Filed: Jan. 28, 2002
(86) PCT No.: PCT/IB02/00239

(30) Foreign Application Priority Data
Aug. 20, 2001 (DE) 10039376.8

(51) Int. Cl. F21L 4/00

(52) U.S. Cl. 362/207; 362/202

(57) ABSTRACT

The invention concerns a flashlights with a battery housing, with a housing opening for accommodation of flashlight batteries, a closure cap for the housing opening, with an opening side and an opposing cap side and holders located in the closure cap for a spare illuminant, which are shaped in such a way that a first end of the spare illuminant projects on the opening side from the holders, at least one contact spring projecting on the opening side from the holders which can be flexibly deformed in the direction of the cap side for compression retention of the flashlight batteries and a fixed protective element which is located on the first end of the spare illuminant and which projects on the opening side at least up to the first end of the spare illuminant.

### FIELD OF THE INVENTION

The invention is relative to a flashlight with a spare lamp.

### BACKGROUND OF THE INVENTION

Flashlights with spare lamps are basically known. The flashlights comprise a battery housing with a housing opening. The housing opening can be closed with a closing cap. This closing cap receives a spare incandescent bulb. The spare incandescent bulb is usually received in such a manner that the actual glass bulb with the incandescent coil (or spiral or helix), is directed away from the flashlight battery. The pole of the incandescent bulb faces the flashlight battery. The incandescent bulb pole is surrounded by a spiral spring that can be elastically deformed in the direction of the closing cap. Such flashlights have the disadvantage that the pole of the spare incandescent bulb is exposed to jolts from the flashlight battery and can be damaged.

### SUMMARY OF THE INVENTION

The present invention has the task of improving flashlights known in the state of the art.

This task is solved with a flashlight with a battery housing with a housing opening for receiving flashlight batteries, with a closing cap for the housing opening with an opening side and an opposed cap side and with holding means arranged in the closing cap for a spare lamp that are designed in such a manner that a first end of the spare lamp projects on the opening side from holding means, with at least one contact spring projecting on the opening side from the holding means which spring can be elastically deformed in the direction of the cap side for mounting the flashlight batteries under pressure, and with a fixed protective element arranged on the first end of the spare lamp which element projects on the opening side at least to the first end of the spare lamp.

### BRIEF DESCRIPTION OF THE DRAWING

FIG. 1 shows a cross section of a flashlight in accordance with the invention.

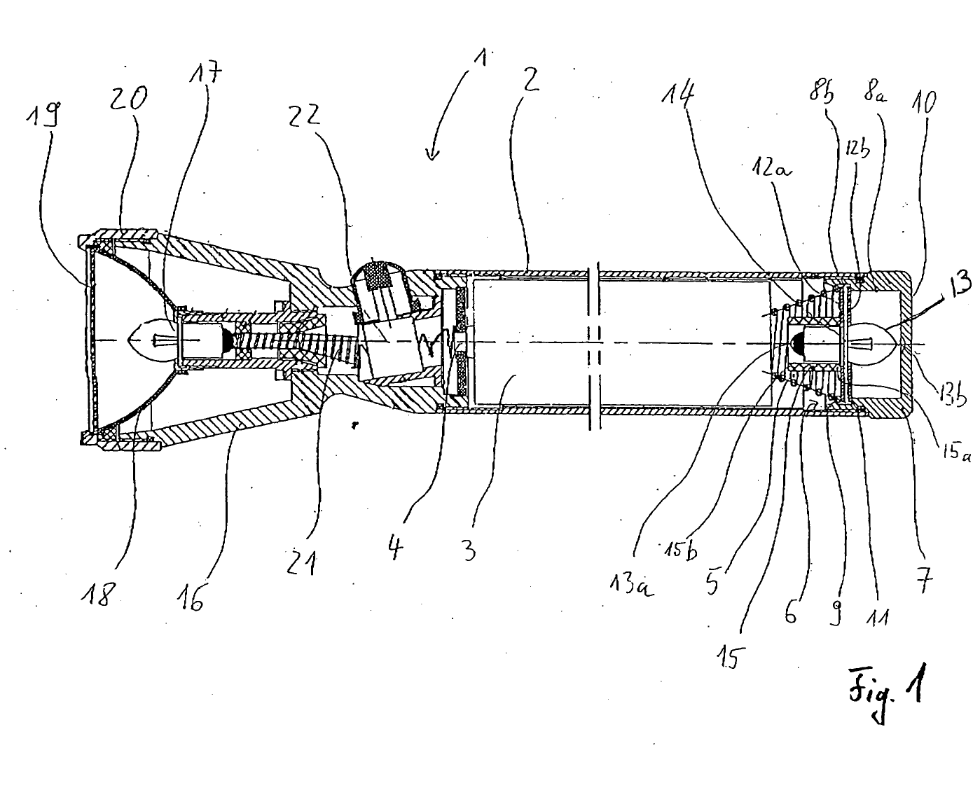

### DETAILED DESCRIPTION OF THE PREFERRED EMBODIMENTS

The flashlight in accordance with the invention comprises a spare lamp. This can be an incandescent bulb with an incandescent coil. The spare lamp is held in the closing cap by holding means. The first end of the spare lamp can extend beyond the opening side of the closing cap into the battery housing of the flashlight when the closing cap closes the housing opening. However, several contact springs projecting on the opening side from the holding means can also be provided. The contact spring is elastically tensioned in the direction of the cap side of the closing cap when the flashlight battery has been placed in the battery housing and the closing cap has been set on. The flashlight battery is prevented by the contact spring from sliding back and forth on account of slight shaking of the flashlight. The contact spring can be elastically deformed in the direction of the cap side beyond the first end of the lamp. This makes it possible that, if the flashlight is sharply and suddenly shaken, the flashlight batteries can knock against the first end of the spare lamp and damage it. A fixed protective element is arranged on the first end of the spare lamp. The protective element is designed in such a manner that the jolts of the flashlight batteries are caught by the protective element and prevents a direct contact between the flashlight battery and the first end of the spare lamp.

The closing cap preferably comprises a support on an inner cap wall.

The support can cooperate with the holding means.

In another preferred embodiment of the invention the inner cap wall is designed to be substantially cylindrical.

It is advantageous if the battery housing is designed to be cylindrical in order to receive a cylindrical flashlight battery. The inner cap wall of the invention continues the inner space of the battery housing in a cylindrical manner. Basically, the outer cap wall can also be cylindrical.

In an advantageous embodiment of the invention the inner cap wall has a first diameter and a second diameter that is larger than the first diameter and the support is formed by the transition from the inner cap wall with the first diameter to the inner cap wall with the second diameter. The cap of this embodiment can be readily manufactured by milling out the interior of the closing cap. The opening-side end of the closing cap is advantageously widened out conically on the opening side.

The holding means preferably comprise a first perforated disk for pushing the first end of the spare lamp through and comprise a second perforated disk for pushing the second end of the spare lamp through and the diameter of the second perforated disk is designed to cooperate with the support.

These holding means can be manufactured in an especially advantageous and simple manner. The first and the second perforated disks can be circular. The second perforated disk rests directly on the support. The first perforated disk is arranged adjacent to the second perforated disk. The diameter of the preferably circular perforated disks is advantageously the same and somewhat smaller than the second diameter of the inner cap wall and larger than the first diameter of the inner cap wall.

The spare lamp advantageously comprises a frame between the first and the second end that has a collar surrounding the spare lamp at least partially. The holding means described above can be used in particular in conjunction with such a spare lamp. The outer diameter of the collar is preferably greater than the diameter of the preferably circular perforations of the perforated disks. The first perforated disk can be guided over the first end of the spare lamp and the second perforated disk can be guided over the second end of the spare lamp. The collar can be fixed between the two perforated disks by pressing the two perforated disks against one another.

The at least one contact spring advantageously comprises a spiral spring tapering down on the opening side and with an end on the cap side. The relaxed cap-side end has a somewhat greater diameter than the first diameter of the inner cap wall.

The spiral springs can basically be elastically deformed not only in the direction of its spiral course but also transversely to it. The cap-side end of the spiral spring can be compressed and clamped under tension into the inner cap wall with the first diameter. The clamping in procedure preferably takes place via the opening-side end of the closing cap which end widens out conically on the opening side.

In an especially preferred embodiment of the invention the protective element is shaped as a sleeve with a cap-side end and with an opening-side end and the sleeve can be guided over the first end of the spare lamp and its cap-side end is intended for the opening-side stop on the first perforated disk and its opening-side end projects beyond the first end of the spare lamp on the opening side.

This is a shape of the protective element that can be manufactured especially simply and economically. The sleeve can be readily guided over the first end of the spare lamp. The sleeve preferably comprises projections formed on the inner wall on the cap-side end. The projections press the sleeve onto the first end of the spare lamp. Thus, the sleeve can not slide off independently from the first end of the spare lamp. The sleeve is preferably dimensioned in such a manner in its length that its cap-side end strikes against the first perforated disk and its opening-side end projects over the first end of the spare lamp in the direction of the battery when the closing cap has been put on. The first end of the spare lamp is taken completely up in its length in the interior of the sleeve.

Sudden changes of position of the flashlight can result in an elastic deformation of the spiral spring in the direction of the cap side of the closing cap on account of the inertia of the flashlight battery received in it. The battery or parts of the spiral spring can bump against the sleeve thereby. The sleeve is dimensioned in such a manner that direct jolts of the flashlight battery against the first end of the spare lamp are preventable.

The invention is explained in the following using an exemplary embodiment shown in the figures.

Flashlight 1 comprises battery housing 2 into which a three-cell rechargeable flashlight battery is inserted. The plus (positive) pole of flashlight battery 3 makes electrical contact with plus (positive) conductor means 4. The minus (negative) pole of flashlight battery 3 makes electrical contact with contact spring 5.

Battery housing 2 comprises housing opening 6 through which flashlight battery can be inserted and removed. Battery housing 2 comprises an internal thread in the area of housing opening 6. The internal thread cooperates with an external thread of closing cap 7. Screwed-on closing cap 7 is substantially cylindrical in the longitudinal direction of battery housing 2 and comprises cylindrical inner cap wall 8a, 8b. Closing cap 7 comprises opening side 9 and cap side 10 located parallel to it and opposite it. Cap side 10 is completely closed. The external thread is arranged in the area of opening side 9 of closing cap 7. Cylindrical inner cap wall 8a, 8b comprises on the cap side a first diameter 8a followed by, on the opening side, an inner cap wall with a second, somewhat larger diameter 8b. The transition from the cap inner wall with the first diameter 8a to the cap inner wall with the second diameter 8b forms a support 11. Holding means 12a, 12b for spare incandescent bulb 13 rest on support 11. The holding means consist of a first 12a and a second 12b perforated disk that have the same diameter and the same perforation diameters. The first perforated disk 12a is arranged on the opening side parallel to the second perforated disk 12 resting directly on support 11.

Spare incandescent bulb 13 has a first end 13a with a lamp pole and has a second end 13b comprising an incandescent coil surrounded by a glass bulb. Circumferential collar 14 is designed between first end 13a and second end 13b of the spare incandescent bulb. The outside diameter of collar 14 is larger than the perforation diameter of perforated disks 12a, 12b. Spare incandescent bulb 13 can therefore be held fast on collar 14 between the first 12a and the second 12b perforated disk. The interval between the second perforated disk 12b and cap side 10 of closing cap 7 is large enough to receive second end 13b of spare incandescent bulb 13.

On the opening side contact spring 5 follows first perforated disk 12a. Contact spring 5 is designed here as a spiral spring tapering down conically on the opening side. Spiral spring 5 is at the same time the minus conductor means of flashlight 1. It has an opening-side end 5a and a cap-side end 5b. Opening-side end 5a has a lesser diameter than cap-side end 5b. Cap-side end 5b of the spiral spring can be fixed (e.g., clamped or inserted) under a slight compression of spiral spring 5 into closing cap 7 in the area of the inner cap wall with the second diameter 8b. Spiral spring 5 fixed in closing cap 7 holds first 8a and second 8b perforated disks fast on support 11. Spare incandescent bulb is also fixed therewith by its collar 14 in closing cap 7.

When closing cap is screwed on and flashlight battery 3 inserted, spiral spring 5 is slightly compressed in the direction of closing cap 7. The seating under pressure of flashlight battery 3 presents it from sliding back and forth. Opening-side end 9 of closing cap 7 widens out conically on the opening side at an angle of approximately 45° in order to facilitate the fixing of cap-side end 5b of the spiral spring. Closing cap 7 runs around a rubber O-ring on the cap side of the external thread.

The first end 13a of spare incandescent bulb 13 is surrounded by sleeve 15. Sleeve 15 consists of solid plastic. Sleeve 15 has a cap-side end 15a that strikes the first perforated disk 8b and has an opening-side end 15b that terminates in the longitudinal direction at the level of the first end 13a of spare incandescent bulb with the latter.

It is basically conceivable that as a result of sudden movements of flashlight 1 the inertia of flashlight battery 3 could cause a deformation of spiral spring 5 in the direction of closing cap 7 beyond first end 13a of spare incandescent bulb 13. In principle, spiral spring 5 can be compressed almost into one plane given a sufficiently expenditure of force. Sleeve 15 protects first end 13a of spare incandescent bulb 13 in that it catches or absorbs jolts of flashlight battery 3 and conducts them via first perforated disk 8b into closing cap 7. Sleeve 15 prevents a direct contact of jolts between the battery minus pole and the first end 13a of spare incandescent bulb 18.

Flashlight 1 comprises flashlight head 16 on the end opposite closing cap 7. Flashlight head 16 has incandescent bulb 17 held approximately in the middle which bulb is surrounded by parabolic reflector 18 closed by lens 19 at the head end. Incandescent bulb 17 is held by a frame on flashlight head 16. Lens 19 and reflector 18 are permanently connected to unscrewable section 20 of the flashlight head. The collar of incandescent bulb 17 forms one contact and the pole of incandescent bulb 17 which pole faces the battery housing forms another contact of incandescent bulb 17. The other contact of incandescent bulb 17 is electrically connected via wire spring 21 to switch 22. Switch 22 is electrically connected for its part to plus conductor means 4.

1-12 (canceled).

13. A flashlight comprising
a battery housing comprising a housing opening for receiving flashlight batteries,
a closing cap for the housing opening with an opening side and an opposed cap side,
a holding means arranged in the closing cap for removably holding a spare bulb having a first end and a second end, such that when the spare bulb is in place the first end projects on the opening side from the holding means,
at least one contact spring projecting on the opening side from the holding means, which spring is elastically deformable in the direction of the cap side for mounting flashlight batteries under pressure, and
a fixed protective element arranged to cover the first end of a spare bulb which protective element projects on the opening side at least to the first end of the spare bulb.

14. The flashlight according to claim 13, characterized in that the closing cap comprises a support on an inner cap wall.

15. The flashlight according to claim 14, characterized in that the inner cap wall is substantially cylindrical.

16. The flashlight according to claim 14, characterized in that the inner cap wall has a first diameter and a second, larger diameter and that the support is formed by the transition from the inner cap wall with the first diameter to the inner cap wall with the second diameter.

17. The flashlight according to claim 14, characterized in that the holding means preferably comprises a first perforated disk for pushing the first end of a spare bulb through, and further comprises a second perforated disk for pushing the second end of the spare bulb through, wherein the diameter of the second perforated disk cooperates with the support.

18. The flashlight according to claim 16, characterized in that the at least one contact spring comprises a spiral spring tapering down on the opening side of the housing, and has a relaxed end on the cap side, and wherein the relaxed end has a greater diameter than the first diameter of the inner cap wall.

19. The flashlight according to claim 13, which further comprises a spare bulb that comprises a frame between the first end and the second end, and wherein the flashlight further comprises a collar which at least partially surrounds the spare bulb at the frame.

20. The flashlight according to claim 19, characterized in that the holding means preferably comprises a first perforated disk for pushing the first end of a spare bulb through, and further comprises a second perforated disk for pushing the second end of the spare bulb through, wherein the diameter of the second perforated disk cooperates with the support, wherein the diameters of the perforations of the first and second perforated disks are smaller than the diameter of the collar.

21. The flashlight according to claim 17, characterized in that the protective element is shaped as a sleeve with a cap-side end and with an opening-side end, wherein the sleeve is adapted to fit over the first end of a spare bulb, wherein the cap-side end is positioned to contact the first perforated disk, and wherein the opening-side end projects beyond the first end of the spare bulb on the opening side of the housing.

22. The flashlight according to claim 21, characterized in that the sleeve has projections formed on the inner wall on the cap-side end.

23. The flashlight according to claim 13, characterized in that the housing opening comprises an internal thread, and the closing cap comprises an external thread corresponding to the internal thread and having an cap-side end, wherein an O-ring is on the cap-side end of the external thread.

24. The flashlight according to claim 13, characterized in that the opening side of the closing cap widens out conically.
